(19) United States
(12) Patent Application Publication
(10) Pub. No.: US 2013/0001176 A1
(43) Pub. Date: Jan. 3, 2013

(54) FLUID FILTRATION SYSTEM WITH ROTATING FILTER ELEMENTS AND METHOD OF USING THE SAME

(75) Inventors: Alan W. Wells, Peoria, IL (US); Eric J. Herron, Chillicothe, IL (US); Steven Tian, Bloomington, IL (US)

(73) Assignee: Caterpillar Inc., Peoria, IL (US)

(21) Appl. No.: 13/173,889

(22) Filed: Jun. 30, 2011

(51) Int. Cl. B01D 36/00; B01D 37/00

(52) U.S. Cl. 210/806; 210/323.1; 210/335; 210/149; 210/767

(57) ABSTRACT

A fluid filtration system for use with an internal combustion engine includes a fluid inlet, a fluid manifold fluidly connected to the fluid inlet, and a plurality of filter elements rotatably coupled to the fluid manifold such that an order of fluid flow through the plurality of filter elements is varied according to a position of an individual fuel filter element of the plurality of fuel filter elements with respect to the fluid manifold. The fluid filtration system may be configured such that fluid flows in series through the plurality of filter elements and the plurality of filter elements is configured to be rotated such that the order of fluid flow through the plurality of filter elements is varied such that a filter element of the plurality of filter elements which was previously a final filter element in the series becomes a first filter element in the series.

### TECHNICAL FIELD

The present disclosure relates generally to fuel filtering systems and methods and, more particularly, to systems and methods for changing an order through which fuel filtration occurs through a plurality of fuel filters.

### BACKGROUND

Engines, including compression-ignition engines, spark-ignition engines, gasoline engines, gaseous fuel-powered engines, and other internal combustion engines, may operate more effectively with fuel from which contaminates, such as particulate matter or water, have been removed prior to the fuel reaching a combustion chamber of the engine. In particular, fuel contaminates, if not removed, may lead to undesirable operation of the engine and/or may increase the wear rate of engine components, such as, for example, fuel system components, including fuel injectors.

Effective removal of contaminates from the fuel system of a compression-ignition engine may be particularly important. In some compression-ignition engines, air is compressed in a combustion chamber, thereby increasing the temperature and pressure of the air, such that when fuel is supplied to the combustion chamber, the fuel and air ignite. If contaminates are not removed from the fuel, the contaminates may interfere with and/or damage, for example, fuel injectors, which may have orifices manufactured to exacting tolerances and shapes for improving the efficiency of combustion and/or reducing undesirable exhaust emissions. Moreover, the presence of contaminants in the fuel system may cause considerable engine damage and/or corrosion in the injection system.

Fuel filtration systems serve to remove contaminates from the fuel. For example, some conventional fuel systems may include a primary fuel filter, which removes water and large particulate matter, and a secondary fuel filter, which removes a significant portion of remaining (e.g., smaller) contaminates, such as fine particulate matter. In particular, a typical secondary filter may include multiple filter elements arranged such that fuel flows through each of the multiple fuel filters in series. Thus, in a system including a primary filter and a secondary filter, a given volume of fuel is filtered via filtration media multiple times—once in the primary filter, where water and relatively large particulate matter may be removed, and additional times in the secondary filter, where relatively small particulate matter may be removed. In some systems, attempts to improve the effectiveness of filtration systems have resulted in providing additional, separate fuel filters arranged to supplement the primary and secondary fuel filters.

One method for arranging a series of fuel filters is described in U.S. Pat. No. 7,828,154 (“the '154 patent”) issued to Ringenberger on Nov. 9, 2010. Specifically, the '154 patent discloses a fuel treatment assembly housing and a method in which fuel is passed in series through a plurality of filter elements attached to a common manifold. Although the fuel treatment assembly described in the '154 patent may benefit from its capacity to filter the fuel through multiple elements, and thus improve the total filtering efficacy, the '154 patent presents a system that includes a first filter element which is always the first in the series of filter elements, therefore relying upon the first filter element to perform all initial filtering prior to filtering by the later filter elements in the series.

### SUMMARY

[[This section to be completed upon final approval of the claims.]].

### BRIEF DESCRIPTION OF THE DRAWINGS

FIG. 1 is a schematic illustration of an exemplary embodiment of a power system;

FIG. 2 is a schematic, side elevation view of an exemplary embodiment of a filter assembly; and

FIG. 3 is a schematic, bottom elevation view of the filter assembly shown in FIG. 2.

FIG. 4 is a schematic, bottom-elevation view of a top section of an exemplary embodiment of a manifold of a filter assembly.

FIG. 5 is a schematic, side elevation view of a manifold plate of an exemplary embodiment of a manifold of a filter assembly.

FIG. 6 is a schematic, bottom elevation view of a top plate of an exemplary embodiment of a filter assembly.

FIG. 7 is a schematic, exploded view of an alternative exemplary embodiment of a filter assembly.

### DETAILED DESCRIPTION

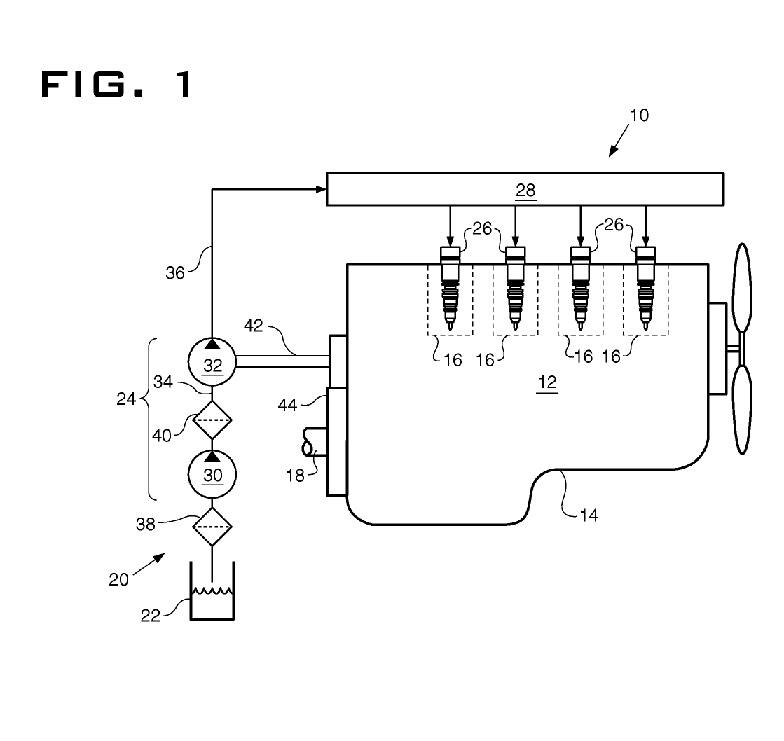

FIG. 1 illustrates an exemplary embodiment of a power system 10 configured to convert fuel and air into mechanical work. Power system 10 includes an engine 12 (e.g., a four-stroke compression-ignition engine). One skilled in the art will recognize that engine 12 may be any type of internal combustion engine, such as, for example, a spark-ignition engine, a gasoline engine, or a gaseous fuel-powered engine. Engine 12 may include a block 14 that at least partially defines a plurality of combustion chambers 16. As shown in FIG. 1, engine 12 includes four combustion chambers 16. It is contemplated that engine 12 may include a greater or lesser number of combustion chambers 16 and that combustion chambers 16 may be disposed in any configuration, such as, for example, in an “in-line” configuration, a “V” configuration, or any other known configuration. Engine 12 may include a crankshaft 18 that is rotatably disposed within block 14. Connecting rods (not shown) may connect a plurality of pistons (not shown) to crankshaft 18, so that combustion within a combustion chamber 16 results in a sliding motion of each piston within a respective combustion chamber 16, which, in turn, results in rotation of crankshaft 18, as is conventional in a reciprocating-piston engine.

Power system 10 may include a fuel system 20 configured to deliver injections of pressurized fuel into each of combustion chambers 16 according to a timing scheme, resulting in coordinated combustion within combustion chambers 16. For example, fuel system 20 may be a common rail system and may include a tank 22 configured to hold a supply of fuel, and a fuel pumping arrangement 24 configured to pressurize and direct the fuel to a plurality of fuel injectors 26 associated with combustion chambers 16 via a flow path 28 (e.g., a fuel rail).

For example, pumping arrangement 24 may include one or more pumping devices configured to increase the pressure of the fuel and direct one or more pressurized streams of fuel to flow path 28. According to some embodiments, pumping arrangement 24 may include a low pressure pump 30 and a high pressure pump 32 disposed in series and fluidly connected by way of a fuel line 34. Low pressure pump 30 may include a transfer pump that provides a low pressure fuel feed to high pressure pump 32. High pressure pump 32 may receive a low pressure fuel feed and increase the pressure of the fuel up to as much as, for example, 300 MPa. High pressure pump 32 may be coupled to flow path 28 via a fuel line 36.

According to the exemplary embodiment shown in FIG. 1, low pressure pump 30 and/or high pressure pump 32 may be coupled to engine 12 and may be driven, for example, via crankshaft 18, either directly or indirectly. For example, low pressure pump 30 and/or high pressure pump 32 may be coupled to crankshaft 18 in any manner known to those skilled in the art, such that rotation of crankshaft 18 will result in a corresponding driving rotation of low pressure pump 30 and/or high pressure pump 32. For example, a driveshaft 42 of high pressure pump 32 is shown in FIG. 1 as being coupled to crankshaft 18 via a gear train 44. It is contemplated, however, that low pressure pump 30 and/or high pressure pump 32 may alternatively be driven electrically, hydraulically, pneumatically, or in any other known manner. It is further contemplated that fuel system 20 may also include, for example, a mechanical fuel injection system and/or a hydraulic fuel injection system, where the pressure of the injected fuel is generated and/or enhanced within individual injectors, with or without the use of a high pressure source.

According to some embodiments, a fluid filtration system may include one or more filtering assemblies, such as, for example, a primary filter assembly 38 (also commonly referred to as a “pre-filter”) and/or a secondary filter assembly 40, may be disposed along fuel line 34 (e.g., in a series relationship, as shown), and may be configured to remove contaminates, such as water and/or particulate matter from the fuel. For example, primary filter assembly 38 may include a filter element (not shown) configured to remove water and/or relatively large particulate matter from fuel received from tank 22. According to the present embodiment, secondary filter assembly 40 may include a plurality of filter elements configured to remove particulate matter from fuel that has not been removed via primary filter assembly 38 (e.g., relatively smaller particulate matter), as described in more detail below. For example, primary filter assembly 38 may include a filter element having media configured to remove non-fuel liquid (e.g., water) and/or about 10 micron-size and larger particles, and secondary filter assembly 40 may include a plurality of filter elements having media configured to remove about 3 micron-size and larger particles. While the primary and secondary filter assemblies 38 and 40 are described as having a 10 micron-size porosity and a 3 micron-size porosity, respectively, this is a non-limiting exemplary embodiment, and different porosity sizes are contemplated by this disclosure. Alternative exemplary embodiments include configurations wherein the primary filter assembly 38 is omitted.

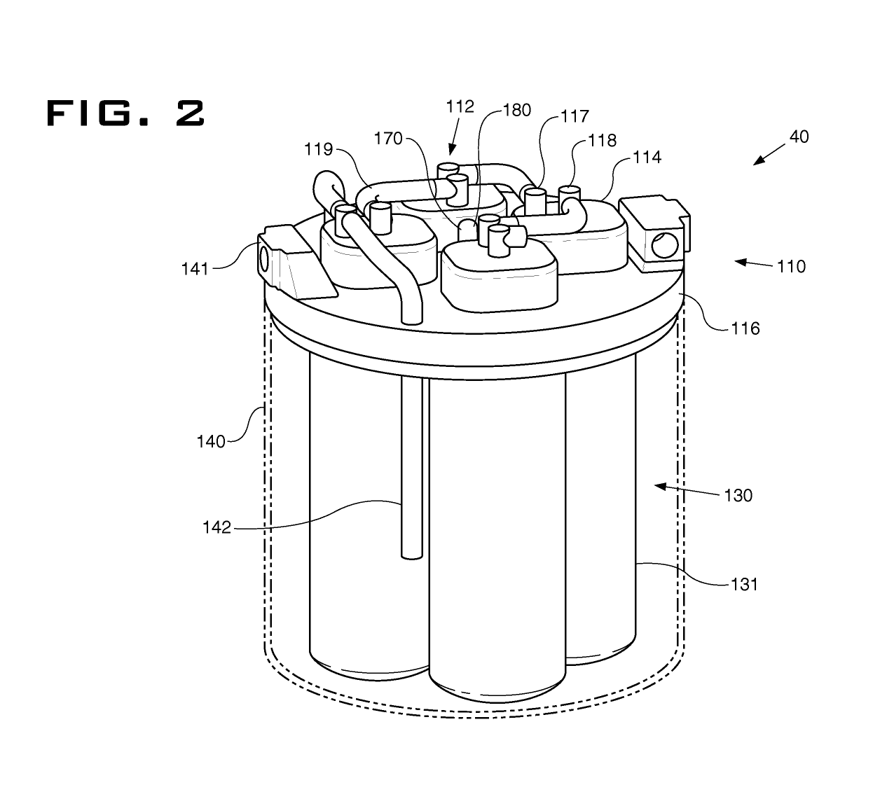

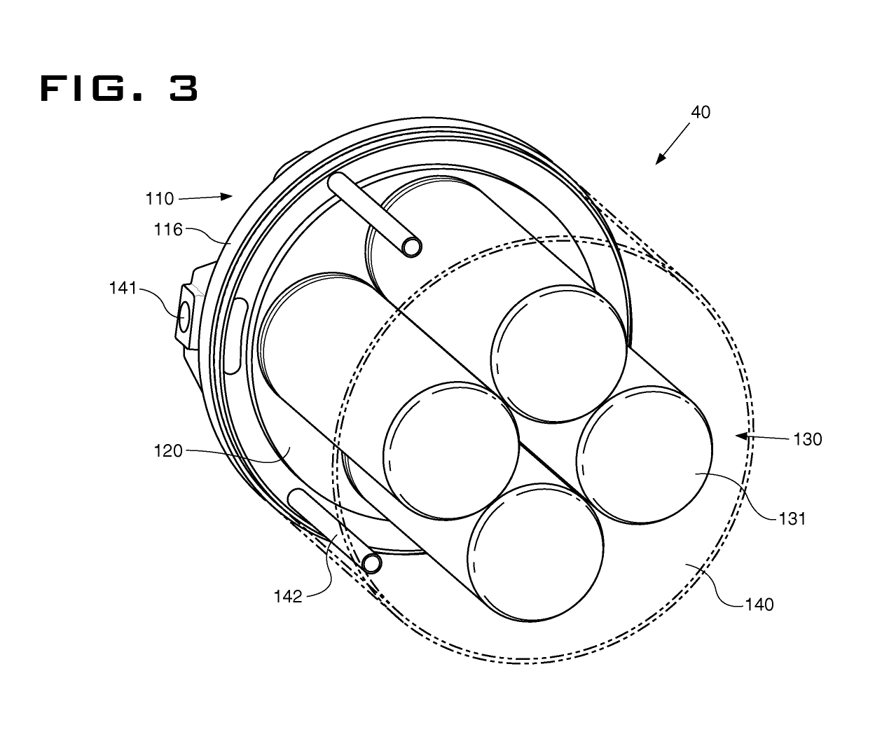

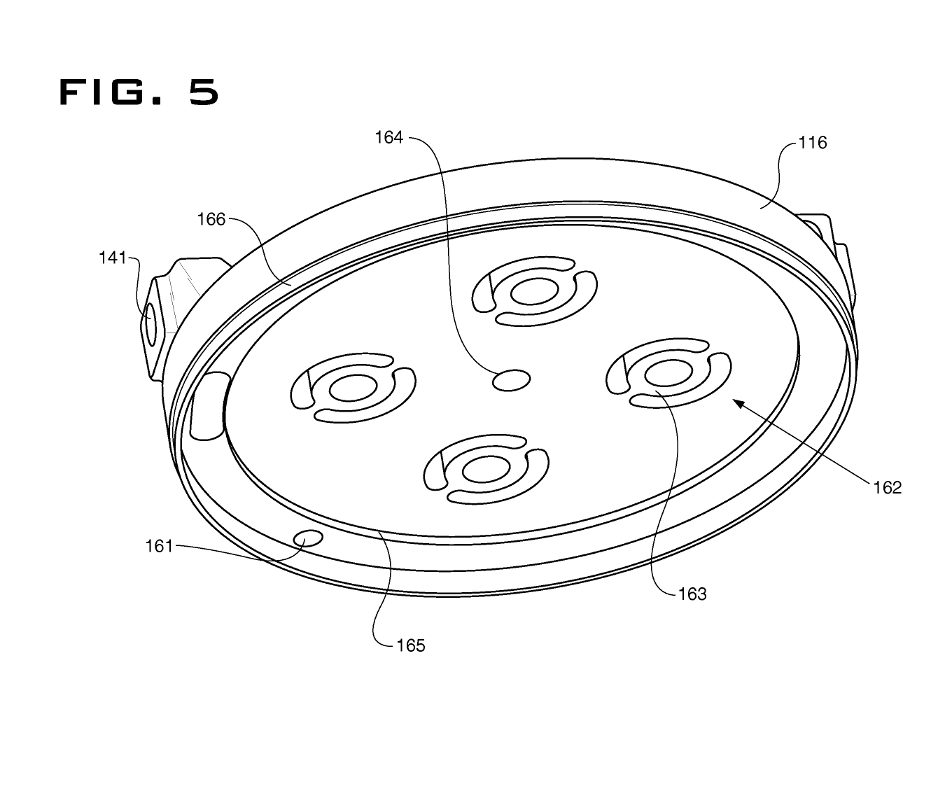

FIG. 2 is a schematic, side elevation view of an exemplary embodiment of a filter assembly, such as may be used as a secondary filter assembly 40. Alternative exemplary embodiments include configurations wherein the exemplary embodiment of a filter assembly may be used for various applications, such as in a separate module to filter fuel within a fuel tank prior to the fuel being introduced to a primary filter assembly 38. FIG. 3 is a schematic, bottom elevation view of the exemplary embodiment of a filter assembly shown in FIG. 2. As shown in FIGS. 2 and 3, the secondary filter assembly 40 includes a manifold 110 including a top section 112 including a plurality of pods 114 and a manifold plate 116 coupled to the plurality of pods 114. The manifold plate 116 will be described in more detail below with respect to FIG. 5.

Each of the plurality of pods 114 includes a pod fluid inlet 117 and a pod fluid outlet 118. A series of fluid transfer conduits 119 are configured to transfer fluid between pods 114 as will be described in detail below. In one exemplary embodiment, a final pod fluid outlet 118 outputs to the fuel line 34 leading to the high pressure pump 32.

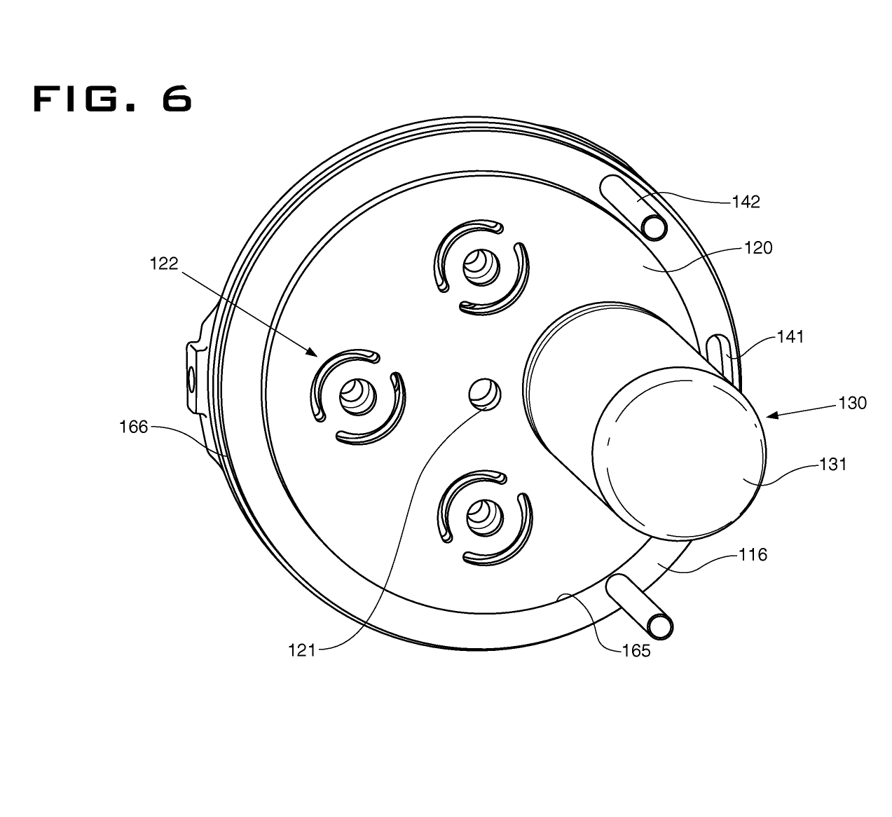

As particularly shown in FIG. 3, the secondary filter assembly 40 also includes a top plate 120 disposed between the manifold plate 116 and a plurality of filter elements 130, each of the plurality of filter elements 130 being disposed within an individual filter housing 131 corresponding to only that filter element 130, i.e., each of the filter elements 130 has its own filter housing 131. In one exemplary embodiment, each of the filter elements 130 and its respective housing 131 may be spin-on type filters. In an alternative exemplary embodiment, each of the filter elements 130 may be a drop-in type filter and the respective housings 131 may be reusable. The top plate 116 will be described in more detail below with respect to FIG. 6. While the illustrated exemplary embodiment includes four filter elements 130, alternative exemplary embodiments include configurations wherein the secondary filter assembly 40 includes two or more filter elements 130. In the present exemplary embodiment, each of the plurality of filter elements 130 includes filter media (not shown) having a similar porosity, e.g., each of the plurality of filter elements 130 may include filter media configured to remove about 3 micron-size and larger particles.

In the present exemplary embodiment, the secondary filter assembly 40 also includes a fluid reservoir 140 substantially surrounding the plurality of filter elements 130 and being configured to supply a fluid to a first filter element 130 of the plurality of filter elements 130 as will be described in more detail below. The manifold 110 includes an inlet 141 which receives fuel from the low pressure pump 130 and deposits the fuel in the fluid reservoir 140. The fluid reservoir 140 includes fluid take-ups 142 disposed therein, wherein the fluid take-ups 142 draw fluid from the fluid reservoir 140 through the manifold plate 116 and into the pod fluid inlet 117. Benefits of using such a configuration will be described in more detail below.

However, it is contemplated that alternative exemplary embodiments may omit the fluid reservoir 140 altogether (not shown). In such alternative exemplary embodiments, fluid may flow from the low pressure pump 130 to the pod fluid inlet 117 without an intermediary fluid reservoir such as fluid reservoir 140. Such alternative exemplary embodiments also provide benefits as will be discussed in more detail below.

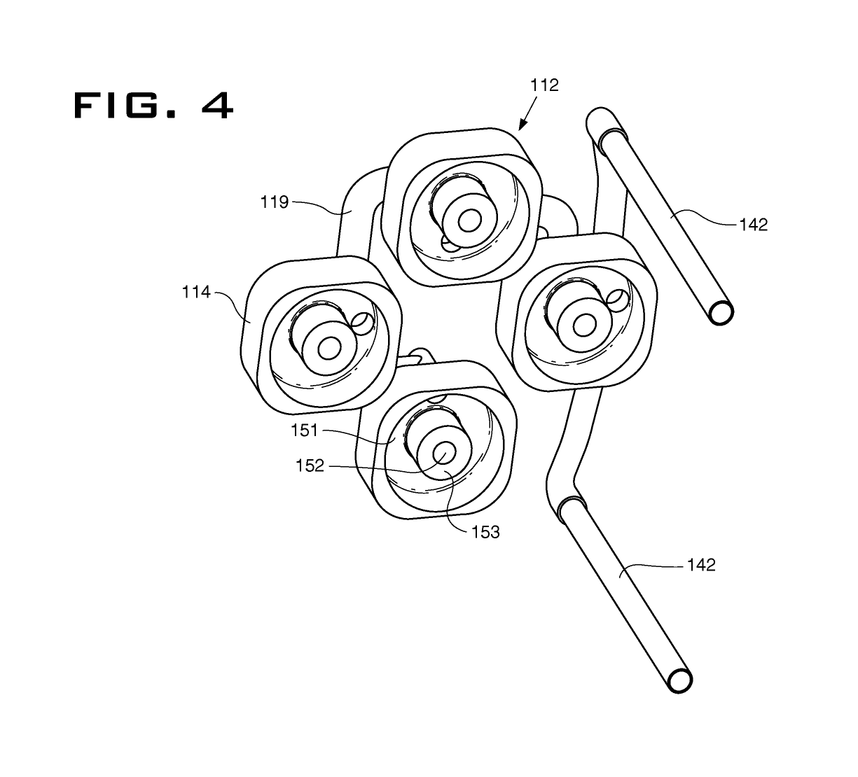

FIG. 4 is a schematic, bottom elevation view of an exemplary embodiment of the top section 112 of the manifold 110 of the filter assembly 40. The fluid take-ups 141 are also illustrated in FIG. 4. The top section 112 includes the plurality of pods 114, each of which includes a pod fluid inlet 117 and a pod fluid outlet 118 (see FIG. 2). Each of the pods 114 includes an outer fluid chamber 151 in fluid communication with the pod fluid inlet 117 and an inner fluid chamber 152 in fluid communication with the pod fluid outlet 118. The outer fluid chamber 151 and inner fluid chamber 152 are separated by an inner wall 153, which in the present exemplary embodiment has a cylindrical shape. In the present exemplary embodiment, the outer chamber 151 corresponds to a fluid inlet (not shown) of a filter element 130 and the inner chamber 152 corresponds to a fluid outlet (not shown) of a filter element 130. In one embodiment, a filter element 130 is configured such that fluid is introduced to the filter along an outer circumference of the filter element 130 and then is filtered by running along the outer circumference, down along a longest axis of the filter element 130 and then up the longest axis again along a center of the filter element 130. Thus, the top section 112 of manifold 110 is configured such that fluid drawn up the fluid take-ups 141 flows into an outer fluid chamber 151 of a first pod 114, through a first filter element 130, then out the inner chamber 152 to a one of the fluid transfer conduits 119 that connects to an outer chamber 151 of another pod 114. The remaining pods 114 are connected in a similar, and serial, manner such that a fluid outlet 118 of a final pod 114 outputs to the fuel line 34 and on to the high pressure pump 32. Although not illustrated in FIG. 4, for the sake of clarity, fluid flow into, and out of, the filter elements 130 also passes through the manifold plate 116 and the top plate 120 as will be described in more detail below.

FIG. 5 is a schematic, side elevation view of a manifold plate 116 of an exemplary embodiment of a secondary filter assembly 40. The manifold plate 116 may be formed of any suitable material; exemplary embodiments include configurations wherein the manifold plate is formed from any of a range of various plastics or metals.

As illustrated, the manifold plate 116 includes the fluid inlet 141 which fluidly couples the fluid reservoir 140 to the fuel line 34 coupled to the low pressure pump 30. In an embodiment where the fluid reservoir 140 is omitted, the fluid inlet 141 may also be omitted. The manifold plate 116 also includes at least one through hole 161 through which the fluid take-ups 142 pass. In the exemplary embodiment wherein only a single fluid take-up 142 is used, the manifold plate 116 may include a single through hole 161 through which the single fluid take-up 142 may pass. In the exemplary embodiment wherein the fluid reservoir 140 is omitted, the through holes 161 may also be omitted.

The manifold plate 116 also includes a plurality of ports 162 that correspond in location to the plurality of pods 114 and the plurality of filter elements 130. In one exemplary embodiment, the number of ports 162 exactly equals the number of filter elements 131. As shown in FIG. 5, the ports 162 are shaped to conform to the outer fluid chamber 151 and inner fluid chamber 152 of the plurality of pods 114 by including an inner wall 163 corresponding to the inner wall 153 of a corresponding pod 114 of the top section 112. The ports 162, and other features of the manifold plate 116, may be formed during an initial forming process of the manifold plate 116, e.g., via an injection molding process, or may be formed in the manifold plate 116 after the manifold plate is initially formed, e.g., by drilling-out or cutting the manifold plate 116.

The manifold plate 116 couples to the top section 112 of the manifold 110. In one exemplary embodiment, the pods 114 of the top section 112 of the manifold 110 are joined to the manifold plate 116 via a joining process, e.g., welding, gluing, etc. In another exemplary embodiment, the pods 114 of the top section 112 of the manifold 110 and the manifold plate 116 are formed such that they are a single, unitary and indivisible component, e.g., they are injection molded as a single piece.

Referring now to FIGS. 2, 3 and 5, the manifold plate 116 also includes a through hole 164 which accommodates a mechanism 170 configured to allow the top plate 120 and plurality of filter elements 130 to rotate with respect to the manifold 110. The mechanism 170 may include an electrical actuator, a hydraulic actuator, a manually operated mechanical linkage or various other similar components. The mechanism 170 may include a component thereof which extends through the through hole 164 and applies a rotational force to the top plate 120 and/or plurality of filter elements 130. A thermal control element 180 may be disposed internally to, or adjacent to, the mechanism 170, although location of the thermal control element 180 is not limited thereto.

In the present exemplary embodiment, the manifold plate 116 includes a seat 165 in which the top plate 120 is disposed. The seat 165 includes a depression in an underside of the manifold plate 116 such that the manifold plate 116 includes a sidewall substantially surrounding the depression.

In the present exemplary embodiment, the manifold plate 116 also includes a shoulder 166 against which an outer circumference of the reservoir 140 may abut. The manifold plate 116 may include slots or tabs (not shown), e.g., along shoulder 166, which may engage slots or tabs (not shown) on the reservoir 140 for attachment of the reservoir 140 to the manifold plate 116.

FIG. 6 is a schematic, bottom elevation view of a top plate 120 of an exemplary embodiment of a secondary filter assembly 40. FIG. 6 illustrates the top plate 120 with respect to the manifold 110 and one of the plurality of filter elements 130. In the illustrated exemplary embodiment, the top plate 120 includes a through hole 121 to accommodate the mechanism 170 therethrough. Alternative exemplary embodiments include configurations wherein the through hole 121 is omitted and the mechanism 170 is coupled to the top plate 120 to rotate the top plate 120 and the plurality of filter elements 130. The top plate 120 also includes a plurality of cutouts 122 having approximately the same shape as the ports 162 in the manifold plate 116. As shown, an individual filter element 130 attaches to the top plate 120 such that a fluid inlet (not shown) of the filter element 130 attaches to an underside of the top plate 120 and the filter element 130 is in fluid communication with a corresponding pod 114 via the top plate 120 and the manifold plate 116.

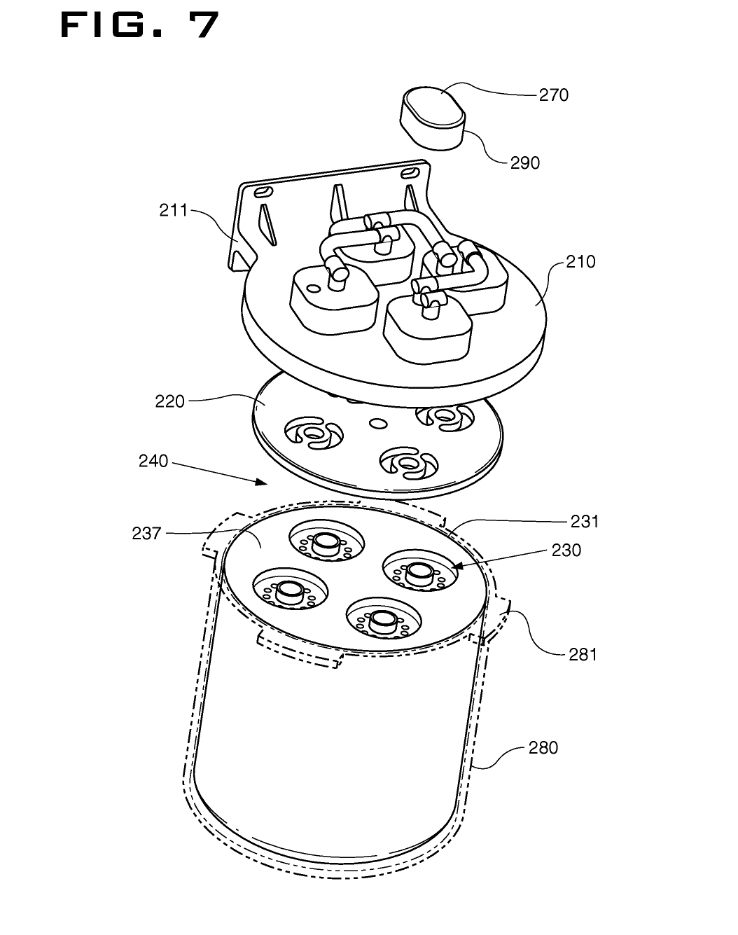

An alternative exemplary embodiment of a secondary filter assembly 240 is illustrated in FIG. 7. For convenience, reference numerals relating to the top section 112 of the manifold 110 will be applied to like elements in the following exemplary embodiment. FIG. 7 is an exploded view of the alternative exemplary embodiment of a filter assembly 240. The alternative exemplary embodiment of a filter assembly 240 is substantially similar to the previously described exemplary embodiment of a filter assembly 40 except that rather than including a plurality of filter elements 130 in individual housings 131 as in the previously described exemplary embodiment, in the present exemplary embodiment the filter elements 230 are contained within a single housing 231.

In the illustrated exemplary embodiment, the single housing 231 is disposed within a container 280 and connected to a manifold 210 via a top plate 220. In one exemplary embodiment, the container 280 may be attached to the manifold 210 via a series of tabs 281 and slots (not shown) in the manifold 210. The manifold 210 is substantially similar to the manifold 110 of the previously described exemplary embodiments with the exception of a mounting bracket 211 disposed on a circumference of the manifold 210. However, exemplary embodiments include configurations wherein the previous exemplary embodiment of a manifold 110 may be modified to include a similar mounting. Alternative exemplary embodiments include alternative mechanisms for fixing the container 280 with respect to the manifold 210. Alternative exemplary embodiments also include configurations wherein the container 280 may be omitted.

Similar to the previously described exemplary embodiment, the present exemplary embodiment includes a mechanism 270 configured to rotate the top plate 220 and plurality of filter elements 230 with respect to the manifold 210. The mechanism 270 may include an electrical actuator, a hydraulic actuator, a manually operated mechanical linkage or various other similar components. The mechanism 270 may include a component thereof which extends through the manifold 210 and applies a rotational force to the top plate 220 and/or plurality of filter elements 230. A thermal control element 290 may be disposed internally to, or adjacent to, the mechanism 270, although location of the thermal control element 290 is not limited thereto.

The individual filter elements 230 function similar to that described above in that they are fluidly isolated from one another within the single housing 231. However, they are physically connected via a filter element connector 237 disposed between the individual filter elements 230. The filter element connector 237 positionally fixes the filter elements 230 with respect to one another. Although the filter element connector 237 is illustrated as a cylinder with a volume substantially surrounding the individual filter elements 230, various alternative embodiments may be applied, e.g., the filter element connector 237 may embody a rigid set of loops (not shown) surrounding a circumference of each filter element 230 or a linear connector (not shown) with arms corresponding to each filter element 230. In addition, while the illustrated exemplary embodiment includes four filter elements 230 alternative exemplary embodiments may include configurations wherein two or more filter elements 230 are included.

A method of filtering a fluid, such as fuel, utilizing the above-described exemplary embodiments of a fluid filtration system will be described in more detail below.

### INDUSTRIAL APPLICABILITY

The primary purpose of the secondary filter assembly 40 or 45 is to filter particulates and/or water from the fluid passing through it, which, in the configuration discussed above, is fuel. Each individual filter element 130 or 230 is capable of filtering a certain percentage of the particulate matter of a predetermined size that is introduced to it, e.g., if the filter element has a 3 micron-size porosity then the filter element may filter about 95% of the 3 micron-size, or larger, particles introduced thereto. That is, some percentage of the particles having a size corresponding to the filter element 130 or 230 porosity size manage to pass through an individual filter element 130 or 230. To compensate for this fundamental principle of filter media, the secondary filter 40 or 45 arranges the filter elements 130 or 230 such that the fluid flows in series through a plurality of filters. Thus, the total percentage of particles of the filter porosity size that are captured increases with each additional filter in the series, e.g., assuming a filtration efficiency of 95% for each filter element, after the first filter element 5% of the targeted particles may remain in the fluid flow, after the second filter element in the series 0.25% of the targeted particles may remain in the fluid flow, after the third filter element in the series 0.0125% of the targeted particles may remain in the fluid flow, after the fourth filter element in the series 0.000625% of the targeted particles may remain in the fluid flow, etc.

In prior applications using a plurality of filters in series, each successive filter element in the series is exposed to a smaller and smaller total amount of particulates. In effect, each successive filter element in the series is exposed to a cleaner fluid stream than the filter element before it due to the filtering action of the previous filter element. Thus, if left in the same order in the series, the first filter element in the series would tend to reach the end of its useful life faster than each successive filter element, e.g., the first filter element in the series would require replacement before the second filter element in the series, the second filter element in the series would require replacement before the third filter element, the third filter element in the series would require replacement before the fourth filter element, etc.

In such prior applications, typically all filter elements were replaced during a single maintenance event. That is, all of the filter elements were replaced when the first filter element required replacement. This lead to the disposal of all filter elements before all of the filter elements had reached the end of their useful life. This process is expensive and creates excess waste. Alternatively, maintenance could be performed to replace each filter element only when replacement was required. However, such a maintenance routine would involve complicated record keeping and multiple servicing intervals and would inevitably lead to recording errors that would result in filters being kept beyond their useful lifetime leading to unwanted damage to the system requiring the filtration.

The present disclosure provides a system and method for fully utilizing all filter elements 130/230 in a filtration system during their useful lives by quickly, easily and reliably changing the order of the filter elements 130/230 in the series without requiring multiple service intervals or extra record keeping. In at least some embodiments, the order of the filter elements 130/230 in the series is changed without any operator, or maintenance technician, intervention.

Referring now to FIGS. 2 and 3, the secondary filter assembly 40 receives fluid, in this exemplary embodiment the fluid is fuel, from the low pressure pump 30 via the fuel line 34. In the present exemplary embodiment the fluid is introduced to the reservoir 140 via the fluid reservoir inlet 141 where it is temporarily stored prior to being drawn into the fluid take-ups 142. The fluid then passes into a pod fluid inlet 117, into a first pod 114 and then into a first filter element 130 (hereinafter referred to as “Filter Element No. 1) connected to the first pod 114. The fluid is filtered by the first filter element 130 and then passes via a first pod outlet 118 to a second pod 114 via a fluid transfer conduit 119. The fluid then continues on to a second filter element 130 (hereinafter referred to as “Filter Element No. 2), a third filter element 130 (hereinafter referred to as “Filter Element No. 3) and a fourth filter element 130 (hereinafter referred to as “Filter Element No. 4) in series in a similar manner. Finally, after passing through a final filter element 130 the fluid is output to the fuel line 34 leading to the high pressure pump 32.

After a period of initial filtration, the first filter element 130, Filter Element No. 1, will have absorbed a larger amount of particulate matter than the remaining filter elements 130, the second filter element 130, Filter Element No. 2, will have absorbed a larger amount of particulate matter than Filter Element Nos. 3 and 4, and the third filter element 130, Filter Element No. 3, will have absorbed more particulate matter than Filter Element No. 4. Therefore, after a predetermined period of filtration, the plurality of filter elements 130 are rotated with respect to the manifold 110 in order to make the loading of particulate matter on the plurality of filter elements 130 more uniform.

In one exemplary embodiment, the plurality of filter elements 130 are simultaneously rotated via the mechanism 170 such that the filter element 130 that was previously the final filter element, e.g., Filter Element No. 4, is rotated to become the first filter element, e.g., it will move to the previous position of Filter Element No. 1. Similarly, Filter Element No. 1 rotates to the previous position of Filter Element No. 2, Filter Element No. 2 rotates to the previous position of Filter Element No. 3, and Filter Element No. 3 rotates to become the final filter element, e.g., it rotates into the previous position of Filter Element No. 4. In the illustrated exemplary embodiment, the plurality of filter elements 130 are rotated through 90 degrees with respect to the manifold 110 after the predetermined period of filtration has elapsed. In one exemplary embodiment, subsequent additional 90 degree rotations may be applied as each filter element 130 is rotated through the various positions with respect to the manifold 110.

As described above, the mechanism 170 may include an electrical actuator, a hydraulic actuator, a manually operated mechanical linkage or various other similar components. The mechanism 170 rotates the filter elements 130 either through a physical connection with the filter elements 130 themselves, or via rotation of the top plate 120. One exemplary embodiment would be to directly connect a rotor (not shown) of an electric motor (shown as mechanism 170) to the top plate 120 to which the plurality of filter elements 130 may be directly attached. However, the disclosure is not limited thereto, and a variety of mechanisms may be employed to generate the rotation.

In one exemplary embodiment, the rotation may be periodic, e.g., a full rotation of the filter elements 130 with respect to the manifold 110 may be made in a predetermined period of time with even incremental movements taking place within the predetermined time period. In another exemplary embodiment, the first portion of the rotation, e.g., a first 90 degree rotation, may be made after a longer period of time than a subsequent rotation, e.g., a second 90 degree rotation, which may in turn be made after a longer period of time than a subsequent third rotation, e.g., a third 90 degree rotation. Thus, pre-loading of the filter elements 130 according to their previous positions may be accounted for as they rotate into position to be the first filter element 130. Methods also include configurations wherein the rotation occurs when an engine is shut down, i.e., substantially concurrently with an engine shut-down command being sent to the engine 12 or at any time thereafter prior to the engine 12 restarting. Alternatively, as described above, the rotation may be configured to occur while the engine 12 is running, i.e., while combustion occurs in the combustion chambers 16.

In the above-described exemplary embodiment the fluid reservoir 140 receives fluid from the low pressure pump 30. The fluid reservoir 140 thus provides a buffer against a flow rate spike along the plurality of filter elements 130. That is, the fluid reservoir 140 may be used to accommodate for differential fluid flow rates between the low pressure pump 30 and the high pressure pump 32. In addition, the fluid reservoir 140 may provide a sampling location (not shown) to allow for fluid sampling or water drainage.

As described above, in one alternative exemplary embodiment, the fluid reservoir 140 may be omitted. In such an alternative exemplary embodiment, the fluid may flow from the low pressure pump 30 into a first pod 114 without an intermediary reservoir. Such a configuration provides a reduction in parts as compared with the previously-described exemplary embodiments and also provides for possibly easier maintenance of the plurality of filter elements 130 as the filter elements 130 would not be disposed in a reservoir of the fluid, which in this embodiment is fuel.

Referring now to FIG. 7, the secondary filter assembly 240 receives fluid, in this exemplary embodiment the fluid is fuel, from the low pressure pump 30 via the fuel line 34. In the present exemplary embodiment the fluid is introduced into a pod fluid inlet 117, into a first pod 114 and then into a first filter element 230 (hereinafter referred to as “Filter Element No. 1) connected to the first pod 114. The fluid is filtered by the first filter element 230 and then passes via a first pod outlet 118 to a second pod 114 via a fluid transfer conduit 119. The fluid then continues on to a second filter element 230 (hereinafter referred to as “Filter Element No. 2), a third filter element 230 (hereinafter referred to as “Filter Element No. 3) and a fourth filter element 230 (hereinafter referred to as “Filter Element No. 4) in series in a similar manner. Finally, after passing through a final filter element 130 the fluid is output to the fuel line 34 leading to the high pressure pump 32.

After a period of initial filtration, the first filter element 230, Filter Element No. 1, will have absorbed a larger amount of particulate matter than the remaining filter elements 230, the second filter element 230, Filter Element No. 2, will have absorbed a larger amount of particulate matter than Filter Element Nos. 3 and 4, and the third filter element 230, Filter Element No. 3, will have absorbed more particulate matter than Filter Element No. 4. Therefore, after a predetermined period of filtration, the plurality of filter elements 230 are rotated with respect to the manifold 210 in order to make the loading of particulate matter on the plurality of filter elements 230 more uniform.

In one exemplary embodiment, the plurality of filter elements 230 are simultaneously rotated via the mechanism 270 such that the filter element 230 that was previously the final filter element 230, e.g., Filter Element No. 4, is rotated to become the first filter element 230, e.g., it will move to the previous position of Filter Element No. 1. Similarly, Filter Element No. 1 rotates to the previous position of Filter Element No. 2, Filter Element No. 2 rotates to the previous position of Filter Element No. 3, and Filter Element No. 3 rotates to become the final filter element 230, e.g., it rotates into the previous position of Filter Element No. 4. In other words, in the illustrated exemplary embodiment, the plurality of filter elements 230 are rotated through 90 degrees with respect to the manifold 210 after the predetermined period of filtration has elapsed. In one exemplary embodiment, subsequent additional 90 degree rotations may be applied as each filter element 230 is rotated through the various positions with respect to the manifold 210.

As described above, the mechanism 270 may include an electrical actuator, a hydraulic actuator, a manually operated mechanical linkage or various other similar components. The mechanism 270 rotates the filter elements 230 either through a physical connection with the filter elements 230 themselves, or via rotation of the top plate 220. One exemplary embodiment would be to directly connect a rotor (not shown) of an electric motor (shown as mechanism 270) to the top plate 220 to which the plurality of filter elements 230 may be directly attached. However, the disclosure is not limited thereto, and a variety of mechanisms may be employed to generate the rotation.

In one exemplary embodiment, the rotation may be periodic, e.g., a full rotation of the filter elements 230 with respect to the manifold 210 may be made in a predetermined period of time with even incremental movements taking place within the predetermined time period. In another exemplary embodiment, the first portion of the rotation, e.g., a first 90 degree rotation, may be made after a longer period of time than a subsequent rotation, e.g., a second 90 degree rotation, which may in turn be made after a longer period of time than a subsequent third rotation, e.g., a third 90 degree rotation. Thus, pre-loading of the filter elements 230 according to their previous positions may be accounted for as they rotate into position to be the first filter element 230. Methods also include configurations wherein the rotation occurs when an engine is shut down, i.e., substantially concurrently with an engine shut-down command being sent to the engine 12 or at any time thereafter prior to the engine 12 restarting. Alternatively, as described above, the rotation may be configured to occur while the engine 12 is running, i.e., while combustion occurs in the combustion chambers 16.

While the rotation described above has generally been described with respect to the inclusion of four filter elements 130/230, the disclosure is not limited thereto. In an embodiment where three filter elements 130/230 are utilized, the degrees of rotation may be increased, e.g., to 120 degrees, and the periods of rotation may be changed. Similarly, if additional filter elements 130/230 are included, the degrees of rotation may be decreased, e.g., to 45 degrees in an exemplary embodiment wherein eight filter elements 130/230 are included.

According to the method of operation described above, each of the plurality of filter elements 130/230, whether there are two or more in the series, is configured to receive a substantially more uniform particulate matter load than if no rotation occurred. In addition, rotation may be easily, quickly and reliably accomplished with little or no record keeping and with little or no maintenance effort.

Although the embodiments described herein have been discussed with respect to use of the filter elements in a fuel filter, one of ordinary skill in the art would understand that the filter element assembly may be applied to a variety of different fluid filtering applications and is not limited to the filtering of fuel.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A fluid filtration system for use with an internal combustion engine, the fluid filtration system comprising:
a fluid inlet
a fluid manifold fluidly coupled to the fluid inlet; and
a plurality of filter elements rotatably coupled to the fluid manifold such that an order of fluid flow through the plurality of filter elements is varied according to a position of an individual fuel filter element of the plurality of fuel filter elements with respect to the fluid manifold.

2. The fluid filtration system of claim 1,
wherein the plurality of filter elements are configured such that fluid flows in series therethrough, and
wherein the plurality of filter elements is configured to be rotated such that the order of fluid flow through the plurality of filter elements is varied such that a filter element of the plurality of filter elements which was previously a final filter element in the series becomes a first filter element in the series.

3. The fluid filtration system of claim 1, wherein the plurality of filter elements includes at least a first filter element and a second filter element, and wherein the fluid manifold includes at least a first fluid connection and a second fluid connection.

4. The fluid filtration system of claim 3,
wherein the first fluid connection includes a first fluid connection inlet and a first fluid connection outlet,
wherein the second fluid connection includes a second fluid connection inlet and a second fluid connection outlet, and
wherein the first fluid connection inlet is coupled to the fluid inlet, the first fluid connection outlet is coupled to the second fluid connection inlet, and the second fluid connection outlet is coupled to either another filter element of the plurality of filter elements or a fluid outlet coupled to the internal combustion engine.

5. The fluid filtration system of claim 3, further comprising a mechanism which is configured to rotate the plurality of filter elements with respect to the fluid manifold,
wherein the mechanism is selected from the group consisting of an electrical actuator, a hydraulic actuator and a manually operated mechanical linkage.

6. The fluid filtration system of claim 3,
wherein fluid flows in series through the first filter element and then the second filter element when the plurality of filter elements are disposed in a first configuration with respect to the fluid manifold, and
wherein fluid flows in series through the second filter element and then the first filter element when the plurality of filter elements are disposed in a second configuration with respect to the fluid manifold.

7. The fluid filtration system of claim 1, further comprising a fluid reservoir substantially surrounding the plurality of filter elements and being configured to supply a fluid to a first filter element of the plurality of filter elements.

8. The fluid filtration system of claim 7, wherein the fluid in the fluid reservoir is fluidly coupled to a low pressure fluid pump.

9. The fluid filtration system of claim 8, further comprising a thermal control element thermally coupled to the plurality of filter elements.

10. The fluid filtration system of claim 1, wherein each of the plurality of filter elements includes an individual filter housing corresponding to only that filter element.

11. The fluid filtration system of claim 1, wherein each of the plurality of filter elements is disposed within a common filter housing.

12. A fluid filter comprising:
a first filter element;
a second filter element; and
a filter element connector that couples the first filter element to the second filter element.

13. The filter element of claim 12, wherein the filter element connector positionally fixes the first filter element with respect to the second filter element.

14. The filter of claim 12, further comprising a thermal control element in thermal communication with the first filter element and the second filter element.

15. The filter of claim 12, wherein the first filter element and the second filter element both contain filter media having a same porosity as each other.

16. The filter of claim 12, wherein the first filter element and the second filter element are disposed within a common filter housing.

17. A method of filtering a fluid, the method comprising:
providing a plurality of filter elements through which the fluid flows in series; and
simultaneously switching the fluid flow path between the plurality of filter elements while keeping a direction through which the fluid flows within each filter element of the plurality of filter elements constant.

18. The method of claim 17,
wherein fluid flows in series through the plurality of filter elements, and
wherein the order of fluid flow through the plurality of filter elements is varied such that a filter element of the plurality of filter elements which was previously a final filter element in the series is configured to rotate to become a first filter element in the series.

19. The method of claim 17, wherein mechanically switching the fluid flow path between the plurality of filter elements includes:
providing a fluid manifold that directs fluid flow between the plurality of filter elements; and
rotating the plurality of filter elements with respect to the fluid manifold via an actuator.

20. The method of claim 19, wherein the actuator is selected from the group consisting of an electrical actuator, a hydraulic actuator and a manually operated mechanical linkage.

21. The method of claim 17 further including:
providing an engine,
wherein the mechanical switching is performed when an engine is shut down.

22. The method of claim 17, further including:
providing an engine,
wherein the mechanical switching is performed periodically during running of the engine.
